(19) United States
(12) Patent Application Publication
(10) Pub. No.: US 2001/0037743 A1
(43) Pub. Date: Nov. 8, 2001

(54) Easy-of-maintenance printing press having a stack of offset perfecting printing units

(76) Inventor: Kenji Takahashi, Chiba (JP)

Correspondence Address: WENDEROTH, LIND & PONACK, L.L.P., 2033 K STREET N. W., SUITE 800, WASHINGTON, DC, 20006-1021, US

(21) Appl. No.: 09/824,645

(22) Filed: Apr. 4, 2001

(30) Foreign Application Priority Data
Apr. 27, 2000 (JP) P2000-127092

(51) Int. Cl. B41F 1/00

(52) U.S. Cl. 101/477

(57) ABSTRACT

A plurality of offset perfecting printing units are stacked up for concurrently printing both sides of a continuous web of paper. Each printing unit comprises blanket cylinders held against each other, two plate cylinders held one against each blanket cylinder, and two inking mechanisms for inking the plate cylinders. The blanket cylinders and plate cylinders of all the printing units are rotatably supported by and between a pair of fixed bearing walls secured to the framework of the machine. The inking mechanisms of all the printing units are supported respectively by and between two pairs of movable bearing walls which are mounted to the framework for movement into and out of contact with the fixed pair of bearing walls in order to carry the inking mechanisms into and out of inking engagement with the plate cylinders of all the printing units. Upon retraction of the movable pairs of bearing walls away from the fixed pair of bearing walls, spaces are created between the plate cylinders and the inking mechanisms for accommodating maintenance personnel. Locking mechanisms are provided for holding the two movable pairs of bearing walls urged against the fixed pair of bearing walls.

### BACKGROUND OF THE INVENTION

This invention relates to printing presses in general and, in particular, to a roll-fed offset web press having a plurality of perfecting printing units stacked one upon another for concurrently printing, by the familiar blanket-to-blanket method of transferring the printed impressions, both sides of a continuous web of paper traveling between the blanket cylinders of the successive printing units. More particularly, the invention concerns how to design such a roll-fed offset perfecting press for easier maintenance, allowing full access of maintenance personnel to its critical working components. The higher production and better printing quality of the presses of the kind in question depend to a large measure on how easy it is to replace the plates on the plate cylinders, to clean the blankets on the blanket cylinders, and to service the inking rollers. Attempts have so far been made for attainment of these objectives. Among them is Japanese Unexamined Utility Model Publication No. 3-23438, which teaches to make the inking assemblies separable from the plate cylinders for greater ease of plate exchange and inking roller servicing. An objection to this known solution is that the inking assemblies are not separable altogether. The maintenance man had to disconnect the successive inking assemblies, one at a time, from the respective plate cylinders, do the necessary services, and then reconnect the inking assemblies to the plate cylinders one after another. This shortcoming is absent from Japanese Patent Publication No. 9-509905, which suggests a stacking of a desired number of offset perfecting printing units. The complete stack of printing units is separable vertically, between the blanket cylinders and the plate cylinders, and the plate cylinders are horizontally movable away from the plate cylinders to provide working spaces for maintenance personnel. The plate cylinders and blanket cylinders are therefore easier to access and service, there being no need for the maintenance man to walk from one printing unit to another. No improvement has been made, however, as to how to access the rollers of the inking assemblies, such rollers being left unseparated from the plate cylinders.

There have been additional problems left unsolved in the art, concerning how to hold the separable parts of the press firmly interconnected during printing operation. Japanese Patent Publication No. 9-509905, supra, teaches use of motor-driven lead screws for moving the movable frame means carrying the cylinders and rollers of the printing units into forced contact with the fixed framework of the machine.

Lead screws as used forth is purpose had some drawbacks. First, the lead screws had to be sufficiently long to provide spaces large enough to accommodate maintenance personnel between the plate cylinders and the blanket cylinders. Such lengthy lead screws have required correspondingly prolonged periods of time for separating and recombining the cylinders in question. Second, with the unavoidable wear of the lead screws with the lapse of time, changes occurred in the number of revolutions that had to be made by the drive motors until the completion of recombination. Third, difficulties were experienced in adjustment of the forces under which the plate cylinders were urged against the blanket cylinders.

Japanese Patent Publication No. 52-19481 proposes use of hooks mounted to fixed frame means, and lockpins mounted to movable frame means carrying parts of the printing means. Also mounted to the fixed frame means are fluid-actuated cylinders for turning the hooks into and out of engagement with the lockpins. The hooks are so shaped as to force the movable frame means against the fixed frame means upon engagement with the lockpins.

Although the hooking of the lockpins is quicker in action than the turning of lead screws. the hooks are required to perform the dual function of positively engaging the lockpins and forcibly pulling the same. The hooks had therefore to be so shaped as to include cam edges capable of urging the lockpins toward the pivots of the hooks as they turn into deeper engagement with the lockpins in sliding contact therewith. The hooks with such critically angled cam edges were difficult to fabricate and, in use, easy to wear out of shape. It was, moreover, difficult to cause the hooks to exert sufficiently great pulling forces solely by means of fluid-actuated cylinders.

### SUMMARY OF THE INVENTION

In view of the foregoing state of the art the present invention has it as an object to make the offset perfecting press of the kind defined, easier of maintenance.

A more specific object of the invention is to design the press so as to enable the maintenance man to change the printing plates, to clean the blankets, and to service the inking means, particularly the final inking rollers, of all or any of the printing units, all at one time.

Another object of the invention is to make the movable frame means, carrying some working components of the press, fastenable to the fixed frame means, carrying other working components, more firmly and positively, by means that are easier of fabrication and more wear-free and longer-lasting in operation, than heretofore.

Stated in brief, the invention provides an easy-to-maintenance, roll-fed, offset perfecting printing press comprising a plurality of offset perfecting printing units stacked up one upon another for printing both sides of a continuous web of paper or like material, each unit comprising a first and a second blanket cylinder held against each other, a first and a second plate cylinder held respectively against the first and the second blanket cylinder, and first and second inking means for inking the first and the second plate cylinder, respectively. The first and the second blanket cylinder, and the first and the second plate cylinder, of all the offset perfecting printing units are rotatably supported by and between a pair of fixed bearing walls which are immovably mounted to the framework of the machine.

The first inking means of all the offset perfecting printing units, on the other hand, are operably supported by and between a first pair of movable bearing walls which are mounted to the framework for movement toward and away from the fixed pair of bearing walls between a working position, where the first inking means of all the offset perfecting printing units are held against the first plate cylinders thereof, and a retracted position where the first inking means of all the offset printing units are held away from the first plate cylinders thereof.

The second inking means of all the offset perfecting printing units are likewise operably supported by and between a second pair of movable bearing walls which are mounted to the framework for movement toward and away from the fixed pair of bearing walls between a working position, where the second inking means of all the offset perfecting printing units are held against the second plate cylinders thereof, and a retracted position where the second inking means of all the offset printing units are held away from the second plate cylinders thereof.

Also included are locking means acting between the first pair of movable bearing walls and the framework, and between the second pair of movable bearing walls and the framework, for firmly retaining the first and the second pair of movable bearing walls in their working positions.

Such being the construction of the offset perfecting printing press according to the invention, it will be appreciated that spaces are created between the first inking means and the first plate cylinders, and between the second inking means and the second plate cylinders, upon retraction of the first and the second movable pair of bearing walls away from the fixed pair of bearing walls. It is understood that these spaces are each large enough to accommodate a maintenance man. By entering these spaces, therefore, he can perform such usual maintenance jobs as plate exchange, blanket cleaning, and inking roller servicing, all at one time. Particularly, he has full access to the final inking rollers as the stack of offset printing units are separated between the inking means and the plate cylinders.

The present invention also concerns the locking means of improved construction, comprising lockpins mounted fast at least one on each of the two movable pairs of bearing walls, and hooks mounted to the framework for movement into and out of locking engagement with the respective lockpins. Each hook is not directly mounted to the framework but via a carriage which is mounted to the framework and which is constrained to linear reciprocation relative to the framework in the direction of movement of the movable bearing walls toward and away from the fixed bearing walls. Actuator means act between the framework and each carriage for causing one associated movable bearing wall, having the lockpin thereon engaged by the hook on the carriage, to be forced against the framework.

Although, typically, each hook is turned by a fluid-actuated cylinder into locking engagement with one lockpin, as in a preferred embodiment of the invention, this cylinder is not used for pulling the lockpin. The complete hook, together with the carriage on which it is mounted, is moved instead in the direction for urging the associated movable bearing wall against the fixed bearing wall. The hook can therefore be simpler in shape than the prior art, all that is required being that it positively engage the lockpin.

Preferably, the actuator means include a fluid-actuated cylinder coupled to each carriage via a torque-amplifying camshaft. The bearing walls will then be all the more strongly forced against the fixed bearing walls, maintaining the offset perfecting printing units positively united and held in good working order throughout any prolonged run of printing operation.

The above and other objects, features and advantages of the invention and the manner of realizing them will become more apparent, and the invention itself will best be understood, from the following description taken together with the attached drawings showing the preferred embodiment of the invention.

### BRIEF DESCRIPTION OF THE DRAWINGS

FIG. 1 is a diagrammatic illustration of the offset perfecting press embodying the novel concepts of this invention, showing the two pairs of movable bearing walls in their working positions, holding the inking means of the press against the plate cylinders for printing;

FIG. 2 is an illustration similar to FIG. 1 except that the movable bearing walls are retracted for maintenance purposes;

FIG. 3 is an illustration somewhat similar to FIG. 1 but showing the framework of the press together with the pairs of movable bearing walls;

FIG. 4 is an enlarged, fragmentary front elevation of the press, showing in particular one of the manual drive means for moving the two pairs of movable bearing walls between the working and the retracted positions;

FIG. 5 is a still more enlarged, fragmentary section taken along the line IV-IV in FIG. 4 and showing in particular the same manual drive means;

FIG. 6 is an enlarged, fragmentary elevation showing how each movable bearing wall of the FIG. 1 press has its top edge engaged with the framework for smooth traveling;

FIG. 7 is a still more enlarged, fragmentary section taken along the line VII-VII in FIG. 6;

FIG. 8 is a similar section taken along the line VIII-VIII in FIG. 6;

FIG. 9 is an enlarged, fragmentary horizontal section through the FIG. 1 press, showing in particular one of the locking means for retaining the movable bearing walls against the fixed bearing walls;

FIG. 10 is an elevation of the showing of FIG. 9, as seen in the direction of the arrow X therein; and

FIG. 11 is an exploded perspective view of the showing of FIG. 9, as seen in the direction of the arrow XI therein.

### DESCRIPTION OF THE PREFERRED EMBODIMENT

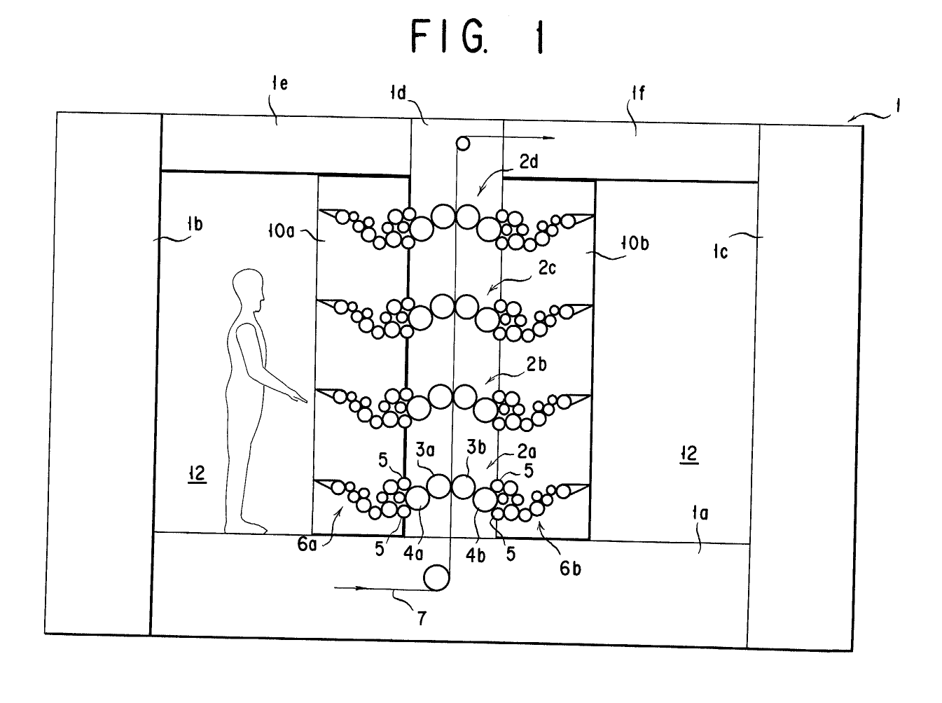

The present invention will now be described in detail as adapted specifically for a four-color, roll-fed, offset perfecting press. As illustrated in FIG. 1, the representative press has a framework 1 in which there are mounted, in a manner to be set forth subsequently, four offset perfecting printing units 2a, 2b, 2c and 2d in a stack. Each printing unit comprises two blanket cylinders 3a and 3b which are held opposite each other, two plate cylinders 4a and 4b in rolling contact with the respective blanket cylinders 3a and 3b, and inking means 6a and 6b including final inking rollers 5 which make direct contact with the plate cylinders 4a and 4b for inking the printing plates thereon.

A continuous web of paper 7 travels upwardly through the stack of printing units 2a-2d, passing between the pairs of opposed blanket cylinders 3a and 3b of each unit. The printing units 2a-2d print both sides of the web 7 by the blanket-to-blanket method, using the blanket cylinder of the opposite sides of the web as the impression cylinders.

As will be understood from FIGS. 1-3, the framework 1 comprises a platform 1a, two pairs of vertical framing members 1b and 1c extending upwardly from the pair of opposite ends of the platform, a pair of vertical bearing walls 1d erected in the middle of the platform, and a pair of tie beams 1e between the vertical framing member pair 1b and bearing wall pair 1d, and another pair of tie beams 1f between the vertical framing member pair 1c and the bearing wall pair 1d.

The blanket cylinders 3a and 3b and plate cylinders 4a and 4b of all the printing units 2a-2d are rotatably supported by and between the pair of fixed bearing walls 1d. The first inking means 6a of the printing units 2a-2d, on the other hand, are operably supported by and between a first pair of movable bearing walls 10a movably mounted to the framework 1. The second inking means 6b of the printing units 2a-2b are likewise operably supported by and between a second pair of movable bearing walls 10b movably mounted to the framework 1.

The two pairs of movable bearing walls 10a and 10b are movable toward and away from the pair of fixed bearing walls 1d. FIG. 1 shows both pairs of movable bearing walls 10a and 10b held against the pair of fixed bearing walls 1d. When the bearing walls 10a and 10b are in these positions, the first and the second inking means 6a and 6b carried thereby are in their working positions, with the final inking rollers 5 held against the first and the second plate cylinders 4a and 4b of the printing units 2a-2d.

It will also be observed from FIG. 1 that spaces 12 exist between the pairs of vertical framing members 1b and 1c and the pairs of movable bearing walls 10a and 10b when the latter are in the working position. These spaces are sufficiently large to accommodate a maintenance man, allowing him to do any necessary maintenance job on the inking means 6a and 6b in particular.

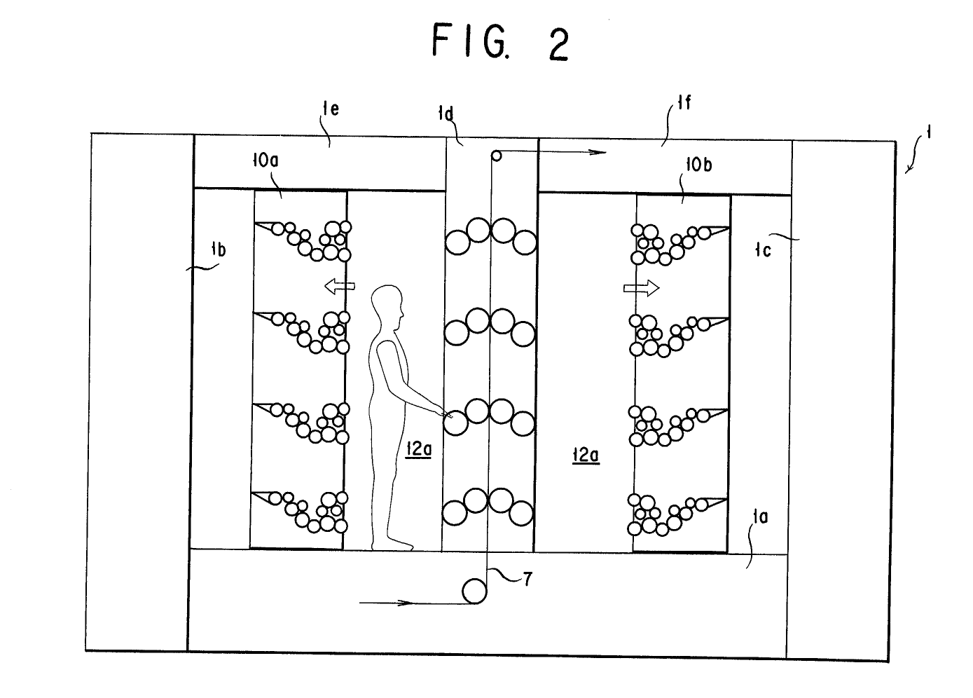

In FIG. 2 are shown both pairs of movable bearing walls 10a and 10b moved away from the pair of fixed bearing walls 1d. The inking means 6a and 6b are now all carried to their retracted positions away from the plate cylinders 4a and 4b of the printing units 2a-2d. Spaces 12a are now created between the plate cylinders 4a and 4b and inking means 6a and 6b of all the printing units 2a-2d for accommodating a maintenance man.

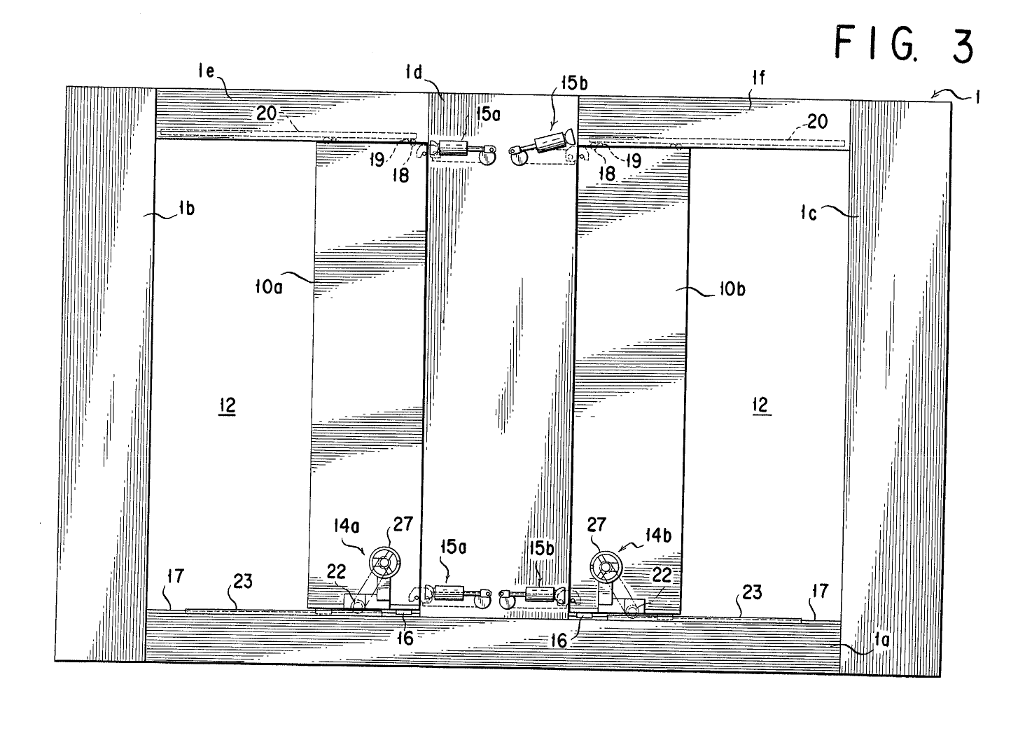

For such movement relative to the framework 1, the movable bearing walls 10a and 10b are each provided with a pair of shoes 16, FIGS. 3-5, of antifriction material on its bottom edge. In the shape of an inverted U in cross section, each pair of shoes 16 are slidably mounted astride a rectilinear guide rail 17 on the platform 1a.

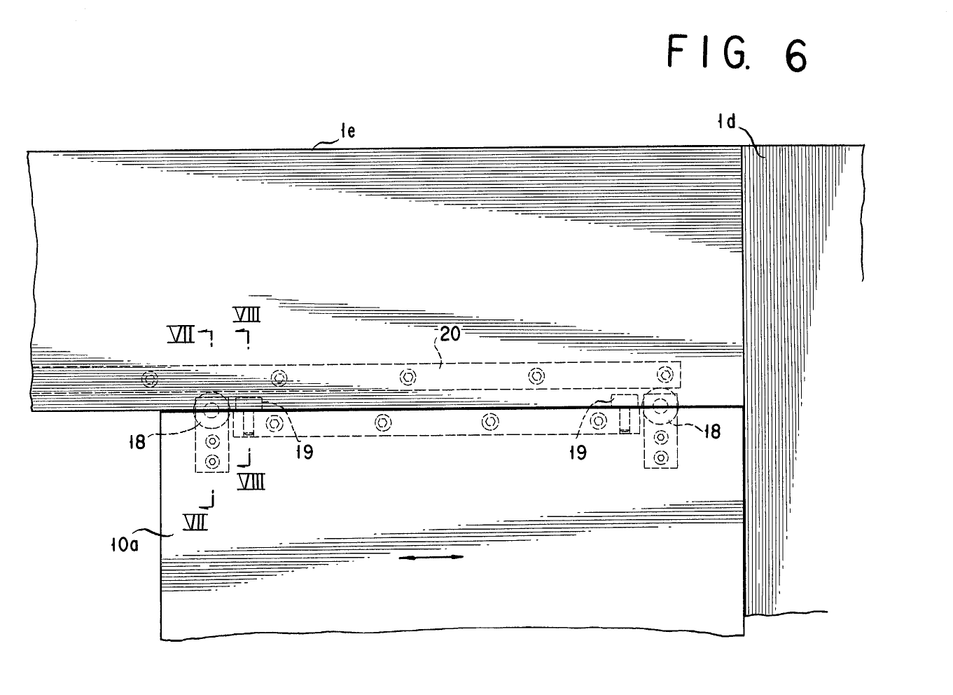

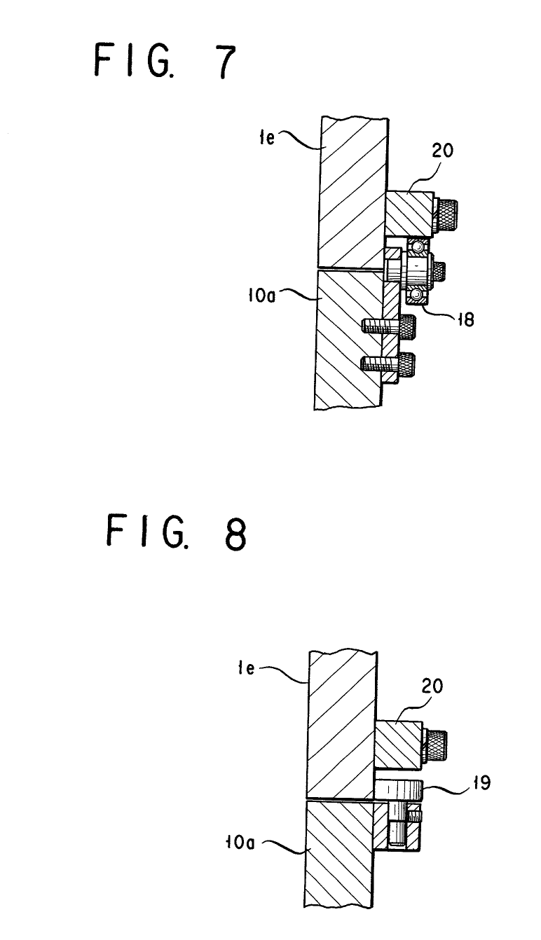

As indicated in phantom outline in FIG. 6 and in an enlarged section in FIG. 7, a pair of rollers 18 are mounted to the top edge of each of the movable bearing walls 10a and 10b in horizontally spaced positions thereon, for rotation about horizontal axes at right angles with the traveling direction of that wall. The pair of rollers 18 on each movable wall make rolling engagement with the underside of a guide rail 20 fastened overhangingly to one associated tie beam 1e or 1f.

As indicated also in phantom outline in FIG. 6 and in an enlarged section in FIG. 8, another pair of rollers 19 are mounted to the top edge of each of the movable bearing walls 10a and 10b in horizontally spaced positions thereon, these for rotation about vertical axes. The pair of rollers 19 on each movable wall make rolling engagement with the inside surface of one associated tie beam 1e or 1f. Thus are the two pairs of movable bearing walls 10a and 10b enabled to travel smoothly between the working and the retracted positions without vertical or lateral displacement. With reference back to FIG. 3 the two pairs of movable bearing walls 10a and 10b are both provided with manual drives 14a or 14b, respectively, thereby to be moved manually between the working positions of FIG. 1 and the retracted positions of FIG. 2. Since the two manual drives 14a and 14b are of like construction except for their opposite orientations, only the manual drive 14a for the first pair of movable bearing walls 10a will be described in detail, with the understanding that the same description substantially applies to the other drive 14b.

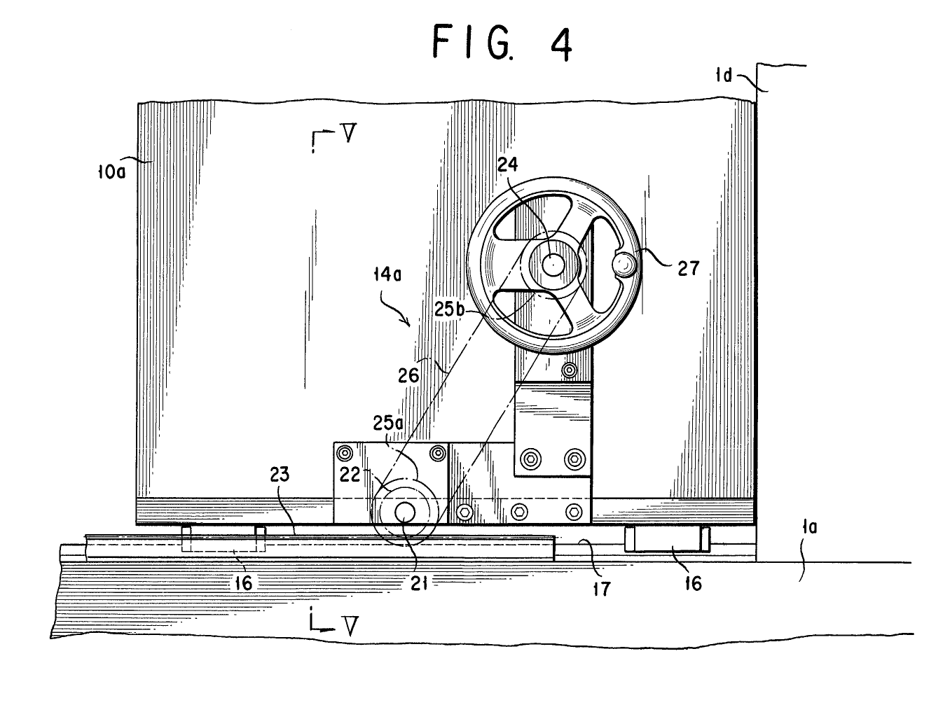

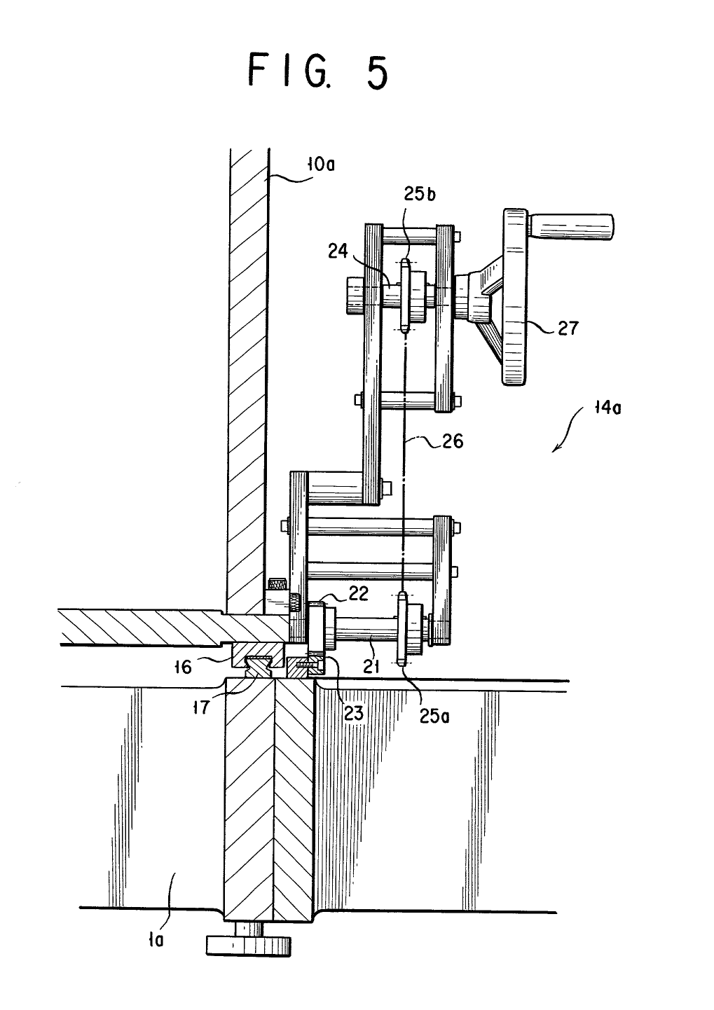

As illustrated on an enlarged scale in FIGS. 4 and 5, the representative manual drive 14a comprises a rack 23 laid on the platform 1a, and a pinion 22 in positive engagement with the rack. The pinion 22 is mounted fast on a pinion shaft 21 rotatably mounted to the pair of bearing walls 10a. An endless chain 26 extends between a sprocket 25a on the pinion shaft 21 and another sprocket 25b on a handwheel shaft 24 which also is rotatably mounted to the pair of movable bearing walls 10a. A handwheel 27 is mounted fast to the handwheel shaft 24.

Thus the bidirectional rotation of the handwheel 27 will be transmitted via the chain-and-sprocket arrangement to the pinion 22. The resulting rotation of the pinion 22 in positive engagement with the rack 23 will cause the pair of movable bearing walls 10a to travel toward and away form the pair of fixed bearing walls 1d. The other pair of movable bearing walls 10b are likewise movable by the turn of the handwheel shown at 14b in FIG. 3.

The instant invention further features two pairs of locking mechanisms 15a, FIG. 3, acting between the pair of fixed bearing walls 1d and the first pair of movable bearing walls 10a, and another two pairs of locking mechanisms 15b acting between the pair of fixed bearing walls id and the second pair of movable bearing walls 10b, for retaining the two pairs of movable bearing walls in their working positions against the risk of backing away therefrom during printing. Two locking mechanisms 15a are provided in vertically spaced positions for each of the first pair of movable bearing walls 10a, and two locking mechanisms 15b in vertically spaced positions for each of the second pair of movable bearing walls 10b. Since all these locking mechanisms are substantially of identical design, only one of them, 15a, the upper one of the two such mechanisms for one bearing wall 10a, will be described in detail, it being understood that the same description substantially applies to each of all the other locking mechanisms.

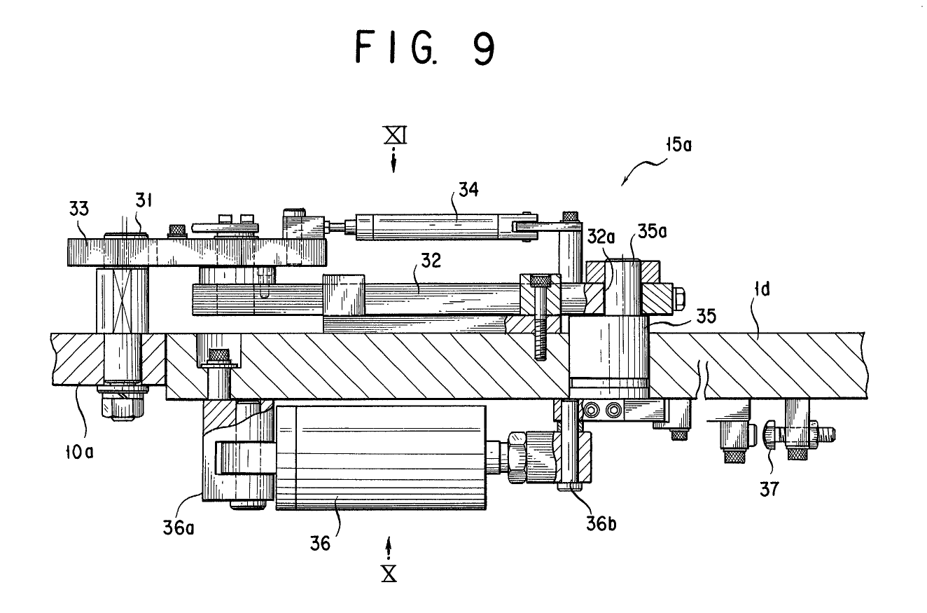

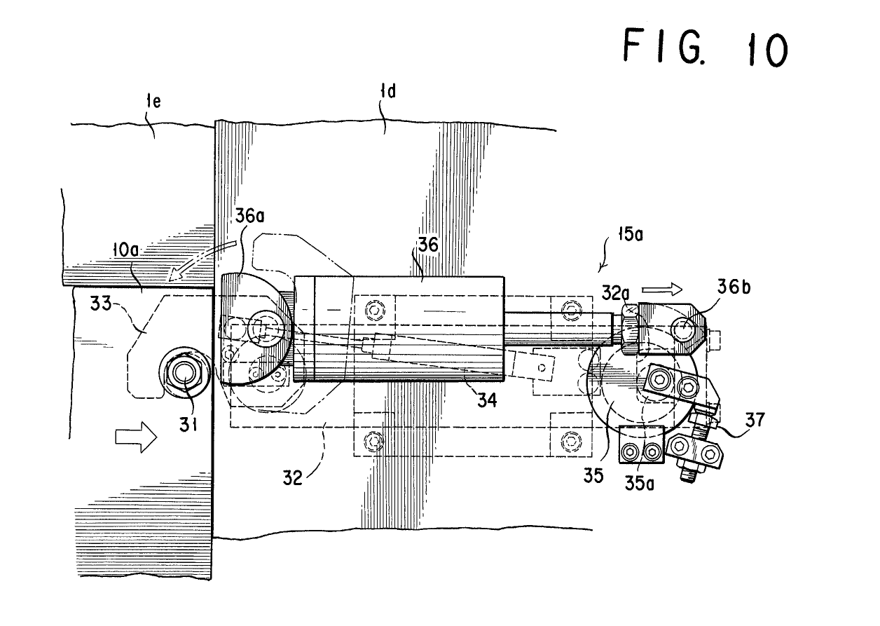

As illustrated on an enlarged scale in FIGS. 9-11, the representative locking mechanism 15a comprises a lockpin 31 mounted fast to the movable bearing wall 10a, and a hook 33 pivotally mounted to a carriage 32 for movement into and out of locking engagement with the lockpin 31. A linear actuator such as a pneumatic cylinder 34 is connected between carriage 32 and hook 33 for actuating the latter. The hook 33 will turn clockwise, as viewed in FIG. 11, into locking engagement with the lockpin 31 upon extension of the cylinder 34, and counterclockwise out of engagement therewith upon contraction of the cylinder. Mounted to the fixed bearing wall 1d, the carriage 32 is constrained to linear travel relative to that wall in the direction of movement of the movable bearing wall 10a toward and away from the fixed bearing wall 1d.

Employed for such travel of the carriage 32 are a torque-amplifying camshaft 35 and a linear actuator such as a hydraulic cylinder 36. The camshaft 35 rotatably extends through the fixed bearing wall id and has a cam 35a projecting eccentrically from one end thereof. The eccentric cam 35a is engaged with the carriage 32 for causing the same to travel toward and away from the lockpin 31 with the bidirectional rotation of the camshaft 35. Since the cam 35a travels arcuately, the carriage 32 receives the cam in its slot 32a which is elongated vertically, taking up the vertical component of the cam motion and utilizing its horizontal component for displacement toward and away from the lockpin 31.

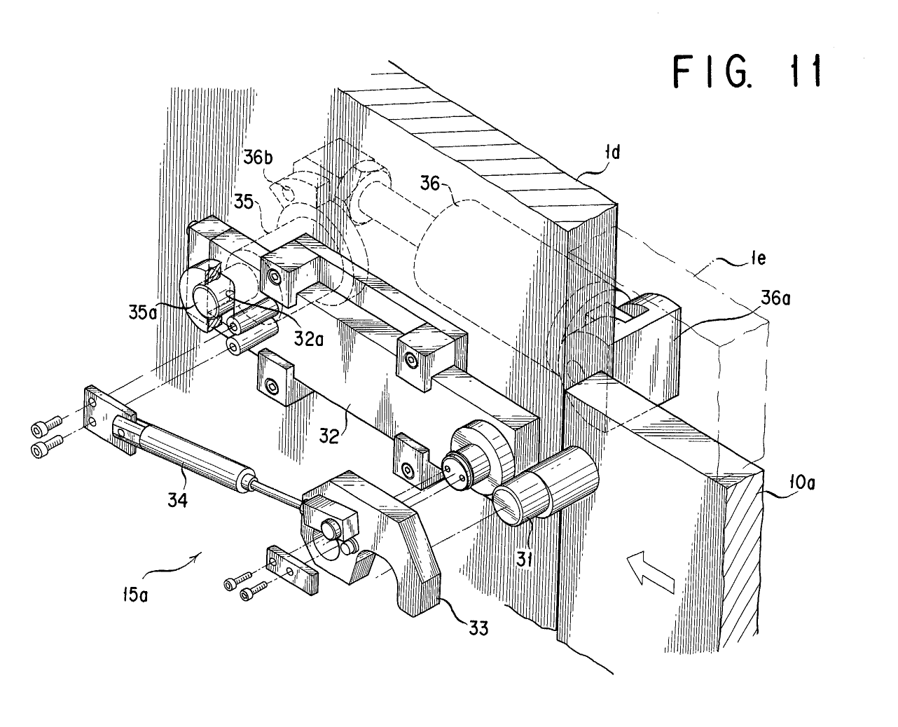

The other end of the camshaft 35 is flanged and pin-joined at 36b to one end of the hydraulic cylinder 36, the other end of which is pivotally supported at 36a on the fixed bearing wall Id. The extension of the hydraulic cylinder 36 is the power stroke, causing the camshaft 35 to turn clockwise as viewed in FIG. 10. The clockwise turn of the camshaft results in turn in the travel of the carriage 32 away from the lockpin 31. An adjustable stop is provided at 37 on the fixed bearing wall 1d for limiting the power stroke of the cylinder 36.

A study of FIG. 9 in particular will reveal that the pin joint 36b, coupling the hydraulic cylinder 36 to the camshaft 35, is at a greater distance from the axis of the camshaft 35 than the eccentric cam 35a is. Consequently, the camshaft 35 functions to amplify the input torque for driving the carriage 32.

Such being the improved construction of the four-color offset perfecting press according to the invention, the two pairs of movable bearing walls 10a and 10b are to be held against the pair of fixed bearing walls Id, as pictured in FIG. 1, for printing. The pairs of movable bearing walls 10a and 10b may be driven into contact with the pair of fixed bearing walls 1d by turning the two handwheels 27 on the platform 1a. No great force will be required for turning the handwheels 27 as the movable bearing walls 10a and 10b ride over the guide rails 17, FIGS. 4 and 5, via the antifriction shoes 16. Further, as these movable bearing walls have their top edges guided both vertically and transversely via the rollers 18 and 19, as in FIGS. 7 and 8, they will travel all the more smoothly.

When the two pairs of movable bearing walls 10a and 10b come to the FIG. 1 working positions, the pneumatic cylinders 34, FIGS. 9-11, of all the locking mechanisms 15a and 15b may be extended for pivoting the hooks 33 into locking engagement with the lockpins 31. Then the hydraulic cylinders 36 on the fixed bearing walls 1d may be extended for moving the carriages 32 away from the lockpins 31, thereby causing the hooks 33 to pull the pairs of movable bearing walls 10a and 10b into forced contact with the pair of fixed bearing walls. Now the final inking rollers 5, FIG. 1, of the inking means 6a and 6b of all the printing units 2a-2d have been brought into proper engagement with the plate cylinders 4a and 4b, making the machine ready for printing.

It will be appreciated that the forces of the hydraulic cylinders 36 will be greatly amplified by the camshafts 35 on being transmitted to the carriages 32. The inking rollers 5 will therefore be held urged against the plate cylinders 4a and 4b throughout any prolonged run of printing operation.

In order to service the machine after printing, the two pairs of movable bearing walls 10a and 10b may be unlocked from the pair of fixed bearing walls id by the reversal of the foregoing procedure. Then the handwheels 27 may be turned for backing the movable bearing walls 10a and 10b from their FIG. 1 to FIG. 2 positions, creating the spaces 12a between the inking means 6a and 6b and the plate cylinders 4a and 4b. By entering these spaces 12a the maintenance man can gain full access to the plate cylinders 4a and 4b and the final inking rollers 5 of the inking means 6a and 6b, in particular, for easy servicing.

Notwithstanding the foregoing detailed disclosure, it is not desired that the instant invention be limited by the exact showing of the drawings or the description thereof. For instance, instead of manually moving the pairs of movable bearing walls 10a and 10b together with the inking means 6a and 6b mounted thereto, they could be motor driven, as by coupling motor drive units to the pinion shafts 21, FIG. 5, either directly or via a suitable drive linkage.

The above and other modifications, alterations, and adaptations of the illustrated embodiments will suggest themselves to one skilled in the art. It is therefore appropriate that the invention be construed broadly and in a manner consistent with the fair meaning or proper scope of the claims which follow.

What is claimed is:

1. An easy-to-maintenance, roll-fed, offset perfecting printing press comprising:
(a) a plurality of offset perfecting printing units stacked up one upon another for printing both sides of a continuous web of paper or like material, each unit comprising a first and a second blanket cylinder held against each other, a first and a second plate cylinder held respectively against the first and the second blanket cylinder, and first and second inking means for inking the first and the second plate cylinder, respectively;
(b) a framework;
(c) a pair of fixed bearing walls immovably mounted to the framework and rotatably supporting therebetween the first and the second blanket cylinder, and the first and the second plate cylinder, of all the offset perfecting printing units;
(d) a first pair of movable bearing walls mounted to the framework and operably supporting therebetween the first inking means of all the offset perfecting printing units, the first pair of movable bearing walls being movable relative to the frame work toward and away from the pair of fixed bearing walls between a working position, where the first inking means of all the offset perfecting printing units are held against the first plate cylinders thereof, and a retracted position where the first inking means of all the offset printing units are held away from the first plate cylinders thereof for providing a space for accommodating maintenance personnel;
(e) a second pair of movable bearing walls mounted to the framework and operably supporting therebetween the second inking means of all the offset perfecting printing units, the second pair of movable bearing walls being movable relative to the framework toward and away from the pair of fixed bearing walls between a working position, where the second inking means of all the offset perfecting printing units are held against the second plate cylinders thereof, and a retracted position where the second inking means of all the offset printing units are held away from the second plate cylinders thereof for providing a space for accommodating maintenance personnel; and
(f) locking means acting between the first pair of movable bearing walls and the framework, and between the second pair of movable bearing walls and the framework, for firmly retaining the first and the second pair of movable bearing walls in their working positions.

2. The offset perfecting printing press of claim 1 wherein the locking means comprises:
(a) a plurality of lockpins formed at least one on each of the first and the second pair of movable bearing walls;
(b) a plurality of carriages mounted to the framework and disposed one adjacent each lockpin, each carriage being movable relative to the framework in a direction of movement of each movable bearing wall toward and away from one fixed bearing wall;
(c) a hook mounted to each carriage for movement relative to the carriage into and out of locking engagement with one lock pin; and
(d) actuator means acting between the framework and each carriage for forcing the latter in such a direction that one associated movable bearing wall, having the lockpin thereon engaged by the hook on the carriage, is urged against the framework.

3. The offset perfecting printing press of claim 2 wherein the actuator means of the locking means comprises:
(a) a camshaft rotatably mounted to the framework and operatively engaged with each carriage in such a way that the carriage linearly travels back and forth relative to the framework with bidirectional rotation of the camshaft; and
(b) a linear actuator mounted to the framework and operatively coupled to each camshaft for causing bidirectional rotation thereof.

4. The offset perfecting printing press of claim 3 wherein the linear actuator is operatively coupled to the camshaft at an eccentric point on the latter, and wherein the camshaft has a cam formed eccentrically thereon and slidably engaged in a slot in the carriage, the eccentric point at which the linear actuator is coupled to the camshaft being spaced a greater distance from an axis of rotation of the camshaft than the eccentric cam is.

5. The offset perfecting printing press of claim 2 wherein the hook of the locking means is pivotable on each carriage for movement into and out of locking engagement with one associated lockpin, and wherein the locking means further comprises a linear actuator acting between each carriage and the hook thereon for pivoting the latter into and out of locking engagement with one associated lockpin.

6. The offset perfecting printing press of claim 1 further comprising drive means for moving each pair of movable bearing walls between the working and the retracted position thereof.

7. The offset perfecting printing press of claim 6 wherein the drive means comprises:
(a) a rack extending along the path of each pair of movable bearing walls between the working and the retracted position thereof;
(b) a pinion rotatably mounted to each pair of movable bearing walls and engaged with one associated rack; and
(c) means for imparting rotation to each pinion.
